(19) United States
(12) Patent Application Publication
(10) Pub. No.: US 2024/0149873 A1
(43) Pub. Date: May 9, 2024

(54) Automated Control Of Vehicle Longitudinal Movement

(71) Applicant: Ford Global Technologies, LLC, Dearborn, MI (US)

(72) Inventors: Shruti Gotadki, Farmington Hills, MI (US); Animesh Sarkar, Farmington Hills, MI (US); Anshuman Jagtap, Dearborn, MI (US); Jared Kuhn, Farmington Hills, MI (US); Nitendra Nath, Troy, MI (US)

(73) Assignee: Ford Global Technologies, LLC, Dearborn, MI (US)

(21) Appl. No.: 18/053,939

(22) Filed: Nov. 9, 2022

(51) Int. Cl. B60W 30/14; B60W 30/16; B60W 40/04; B60W 40/105

(52) U.S. Cl. CPC B60W 30/143; B60W 30/16; B60W 40/04; B60W 40/105; B60W 2420/52; B60W 2554/4041; B60W 2554/4042; B60W 2554/802

(57) ABSTRACT

A method to control speed of a first vehicle is disclosed. The method may include obtaining a first input from a first detection unit. The first detection unit may be configured to monitor vehicles in a first vehicle blind-spot area. The method may further include determining presence of a second vehicle in a first vehicle blind-spot area based on the first input. The method may further include calculating a time spent by the second vehicle in the first vehicle blind-spot area. Furthermore, the method may include determining whether the time spent is greater than a predetermined threshold. Responsive to a determination that the time spent is greater than the predetermined threshold, the method may include comparing a first vehicle range and a run-off area, and updating a first vehicle speed based on the comparison.

### TECHNICAL FIELD

The present disclosure relates to automated control of vehicle longitudinal movement in an advanced driver assistance system (ADAS). Specifically, the disclosure relates to a method and system for controlling vehicle longitudinal movement based on presence of automobiles in a vehicle's blind spot areas.

### BACKGROUND

Adaptive cruise control (ACC) is an advanced driver assistance system (ADAS) feature that automatically controls vehicle speed and helps maintain a predetermined distance from lead vehicles. The ACC feature typically controls vehicle speed based on lead vehicle movement. In particular, the ACC feature may enable a vehicle user to set cruising speed and the predetermined distance from the lead vehicle when the user operates the vehicle. The ACC feature may set the vehicle speed to the cruising speed when the vehicle is in motion. Further, the ACC feature may automatically decrease the vehicle speed when the lead vehicle slows down and increase the vehicle speed when the lead vehicle speeds up.

While the ACC feature enhances user's driving experience, there may be instances where the user may desire additional assistance. For example, the user may desire additional driving assistance when another vehicle is driving side-by-side in adjacent lanes.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example system in which techniques and structures for providing the systems and methods disclosed herein may be implemented.

FIG. 2 depicts a block diagram of an example system for automated control of vehicle longitudinal movement in accordance with the present disclosure.

FIG. 3 depicts a first flow diagram of an example method for automated control of vehicle longitudinal movement in accordance with the present disclosure.

FIG. 4 depicts a second flow diagram of an example method for updating vehicle speed in accordance with the present disclosure.

FIG. 5 depicts an exemplary scenario for automated control of vehicle longitudinal movement in accordance with the present disclosure.

### DETAILED DESCRIPTION

### Overview

The present disclosure describes a system for controlling speed of a first vehicle. The first vehicle may be a fully or a partially autonomous vehicle. The system may detect presence of a second vehicle in a first vehicle blind spot area and adjust the first vehicle speed based on the second vehicle presence. Specifically, the system may adjust the first vehicle speed when the second vehicle is present in the first vehicle blind spot area for a time that may be longer than a predetermined time threshold. In some aspects, the system may increase or decrease the first vehicle speed such that the second vehicle may move away from the first vehicle blind spot area.

In some aspects, the system may obtain the first vehicle speed, a second vehicle speed and relative distance between the first vehicle and the second vehicle. Responsive to obtaining the first vehicle speed, the second vehicle speed and the relative distance, the system may predict presence of second vehicle in the first vehicle blind spot area and estimate the time the second vehicle may be present in the first vehicle blind spot area.

The system may increase the first vehicle speed when there is no lead vehicle in a first vehicle front side or when a distance between the first vehicle and the lead vehicle is greater than a first distance threshold. The system may decrease the first vehicle speed when the distance between the first vehicle and the lead vehicle lead is less than the first distance threshold. In some aspects, the system may decrease the first vehicle speed when there is no trailing vehicle at a first vehicle rear side or when a distance between the first vehicle and the trailing vehicle is less than a second distance threshold.

The present disclosure discloses a vehicle speed control system. The system enables the first vehicle to automatically move away from the second vehicle that may be present in the first vehicle blind spot area. Presence of objects or obstacles (e.g., other vehicles) in vehicle blind spot areas may be uncomfortable for some users, and hence the present disclosure enhances user experience by predicting such uncomfortable scenarios and automatically moving the first vehicle away from the second vehicle. The system increases or decreases the first vehicle speed while ensuring that the first vehicle maintains a predetermined distance from the lead or the trailing vehicles. Therefore, the system ensures that there is no adverse incident while adjusting the first vehicle speed.

### Illustrative Embodiments

The disclosure will be described more fully hereinafter with reference to the accompanying drawings, in which example embodiments of the disclosure are shown, and not intended to be limiting.

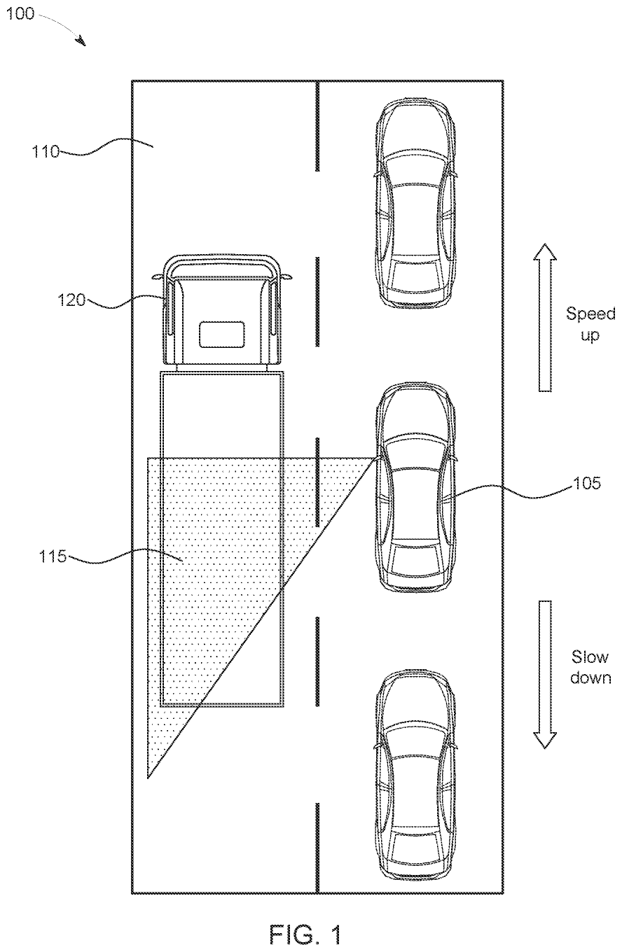

FIG. 1 depicts an example system 100 in which techniques and structures for providing the systems and methods disclosed herein may be implemented. The system 100 may include a vehicle 105. The vehicle 105 may take the form of any passenger or commercial vehicle such as, for example, a car, a work vehicle, a crossover vehicle, a van, a minivan, a taxi, a bus, etc. Further, the vehicle 105 may be configured to operate in a fully autonomous (e.g., driverless) mode or a partially autonomous mode, and may include any powertrain such as, for example, a gasoline engine, one or more electrically-actuated motor(s), a hybrid system, etc.

As shown in FIG. 1, the vehicle 105 may be in motion on a road network 110. The road network 110 may include one or more roads in a region or an area. The region may be, for example, a town or suburb, a city, a state or province, a county, or any other geographic region.

The vehicle 105 may include an adaptive cruise control unit/module (not shown in FIG. 1) that may perform autonomous and/or semi-autonomous functions for the vehicle 105. For example, the adaptive cruise control unit may allow a vehicle operator to set a desired/target vehicle speed. The adaptive cruise control unit may maintain the desired vehicle speed and may automatically increase or decrease vehicle speed when another vehicle approaches near the vehicle 105. In particular, the vehicle 105 may receive inputs from one or more vehicle detection units, and increase or decrease the vehicle speed based on the inputs.

The vehicle detection units (not shown in FIG. 1) may include vehicle camera(s) and/or vehicle sensor(s). The vehicle detection units may monitor vehicles or obstacles around the vehicle 105, such as vehicles travelling in adjacent lanes, vehicles travelling in front and rear of the vehicle 105, and/or the like. In some aspects, the vehicle detection units may be configured to monitor vehicles in vehicle 105 blind spot areas (such as a vehicle blind spot area 115).

The vehicle blind spot area 115 may be an area around the vehicle 105 on the road network 110 that may be outside vehicle operator's vision. In other words, the vehicle blind spot area 115 may be an area or a zone around the vehicle 105 that the vehicle 105 operator may not observe/see via vehicle 105 mirrors (e.g., rear view mirrors) or windows. A person ordinarily skilled in the art may appreciate that although the vehicle blind spot area 115 is shown on vehicle 105 left side, the vehicle blind spot area 115 may be located in vehicle 105 right side as well.

In some aspects, the vehicle detection units may include radar sensors that may be located on vehicle left side and vehicle right side. The radar sensors may monitor vehicles travelling in the vehicle blind spot area 115. For example, the radar sensors may detect another vehicle 120 that may have entered (or be present) in the vehicle blind spot area 115.

The vehicle detection units may be further configured to provide an indication of presence of the other vehicle 120 in the vehicle blind spot area 115 to the vehicle 105 operator. In particular, the vehicle detection units may indicate whether the other vehicle 120 is located in left adjacent lane or right adjacent lane, via vehicle rear view mirrors. For example, the vehicle detection units may overlay the other vehicle 120 image or illuminate a Light Emitting Diode (LED) on a vehicle left side rear view mirror, when the other vehicle 120 is located in the left adjacent lane. In further aspects, the vehicle detection units may transmit the indication associated with the other vehicle 120 presence to the vehicle adaptive cruise control unit. Responsive to receiving the indication, the adaptive cruise control unit may adjust vehicle 105 speed automatically. In particular, the adaptive cruise control unit may increase or decrease vehicle 105 speed such that the other vehicle 120 may move away from the vehicle blind spot area 115.

In some aspects, the vehicle 105 may calculate or estimate an amount of time spent by the other vehicle 120 (or the time that the other vehicle 120 may spend) in the vehicle blind spot area 115, when the vehicle 105 determines that the other vehicle 120 is present (or may be potentially present) in the vehicle blind spot area 115. Responsive to a determination that the time spent (or estimated time) is greater than a predefined threshold, the vehicle 105 (or the adaptive cruise control unit) may adjust the vehicle 105 speed automatically.

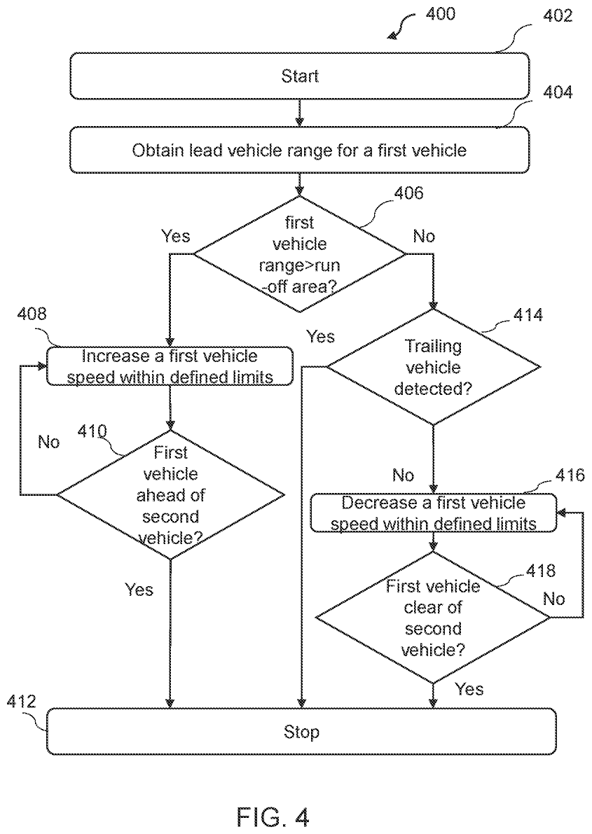

In further aspects, the adaptive cruise control unit may increase or decrease the vehicle 105 speed based on a distance between the vehicle 105 and other vehicles (not shown) travelling in the same lane as the vehicle 105. For example, the vehicle 105 may increase the vehicle 105 speed when a lead vehicle is far from the vehicle 105. Alternatively, the vehicle 105 may decrease the vehicle 105 speed when a trailing vehicle is far from the vehicle 105, or when there is no trailing vehicle. The details of vehicle speed adjustment may be understood in conjunction with FIG. 4.

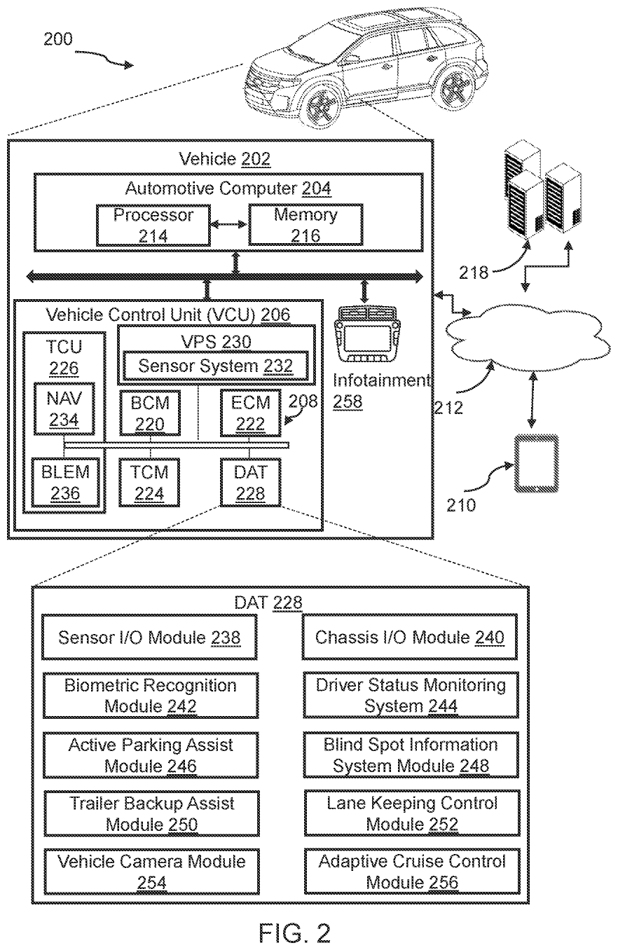

FIG. 2 depicts a block diagram of an example system 200 for automated control of vehicle longitudinal movement or speed, in accordance with the present disclosure. The system 200 may include a vehicle 202. The vehicle 202 may be same as the vehicle 105.

The vehicle 202 may be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features.

A vehicle having Level-1 autonomy may include a single automated driver assistance feature, such as steering or gas pedal assistance. Adaptive cruise control (ACC) is one such example of a Level-1 autonomous system that includes aspects of both gas pedal and steering.

Level-2 autonomy in vehicles may provide driver assist technologies such as partial automation of steering and gas pedal functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as speeding past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as an adverse road incident.

Level-5 AVs may include fully autonomous vehicle systems that require no human input for operation, and may not include human operational driving controls.

In some aspects, the vehicle 202 may include an automotive computer 204 and a Vehicle Control Unit (VCU) 206 that may include a plurality of electronic control units (ECUs) 208 disposed in communication with the automotive computer 204. A mobile device 210, which may be associated with a vehicle operator or user (not shown), may connect with the automotive computer 204 using wired and/or wireless communication protocols and transceivers. The mobile device 210 may communicatively couple with the vehicle 202 via one or more network(s) 212, which connect with the vehicle 202 directly using near field communication (NFC) protocols, Bluetooth® protocols, Wi-Fi, Ultra-Wide Band (UWB), and other possible data connection and sharing techniques.

The network(s) 212 illustrate an example communication infrastructure in which the connected devices discussed in various embodiments of this disclosure may communicate. The network(s) 212 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 204 may be installed in an engine compartment of the vehicle 202 (or elsewhere in the vehicle 202). The automotive computer 204 may be or include an electronic vehicle controller, having one or more processor(s) 214 and a memory 216. The automotive computer 204 may, in some example aspects, be disposed in communication with the mobile device 210 and one or more server(s) 218. The server(s) 218 may be part of a cloud-based computing infrastructure, and may be associated with and/or include a Telematics Service Delivery Network (SDN) that provides digital data services to the vehicle 202 and other vehicles (not shown in FIG. 2) that may be part of a vehicle fleet.

The processor(s) 214 may be disposed in communication with one or more memory devices disposed in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable memory storing automated vehicle longitudinal movement control program code. The memory 216 can include any one or a combination of volatile memory elements (e.g., dynamic random access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The VCU 206 may communicatively couple with the automotive computer 204, and may be configured and/or programmed to coordinate the data between vehicle 202 systems, connected servers (e.g., the server(s) 218), and other vehicles (not shown in FIG. 2) operating as part of a vehicle fleet. The VCU 206 can include or communicate with any combination of the ECUs 208, such as, for example, a Body Control Module (BCM) 220, an Engine Control Module (ECM) 222, a Transmission Control Module (TCM) 224, the Telematics control unit (TCU) 226, a Driver Assistances Technologies (DAT) controller 228, etc. The VCU 206 may further include and/or communicate with a Vehicle Perception System (VPS) 230, having connectivity with and/or control of one or more vehicle sensor system(s) 232 (which may be same as the vehicle detection units described in conjunction with FIG. 1).

The TCU 226 can be configured and/or programmed to provide vehicle connectivity to wireless computing systems onboard and offboard the vehicle 202, and may include a Navigation (NAV) receiver 234 for receiving and processing a GPS signal from GPS, a BLE Module (BLEM) 236, a Wi-Fi transceiver, a UWB transceiver, and/or other wireless transceivers (not shown in FIG. 2) that may be configurable for wireless communication between the vehicle 202 and other systems, computers, and modules. The TCU 226 may be disposed in communication with the ECUs 208 by way of a bus. In some aspects, the TCU 226 may retrieve data and send data as a node in a Controller Area Network (CAN) bus.

In an exemplary aspect, the ECUs 208 may control aspects of vehicle operation and communication using inputs from human drivers, inputs from an autonomous vehicle controller, and/or via wireless signal inputs. The ECUs 208, when configured as nodes in the bus, may each include a central processing unit (CPU), a CAN controller, and/or a transceiver (not shown in FIG. 2).

The BCM 220 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 220 may also operate as a gateway for bus and network interfaces to interact with remote ECUs (not shown in FIG. 2).

The DAT controller 228 may provide Level-1 through Level-4 automated driving and driver assistance functionality that can include, for example, active parking assistance, trailer backup assistance, adaptive cruise control, lane keeping, and/or driver status monitoring, among other features. The DAT controller 228 may also provide aspects of user and environmental inputs usable for user authentication. Authentication features may include, for example, biometric authentication and recognition.

In one example aspect, the DAT controller 228 may include a sensor I/O module 238, a chassis I/O module 240, a Biometric Recognition Module (BRM) 242, driver status monitoring system 244, an active parking assist module 246, a blind spot information system (BLIS) module 248, a trailer backup assist module 250, a lane keeping control module 252, a vehicle camera module 254, an adaptive cruise control module 256 (same as the adaptive cruise control unit described in conjunction with FIG. 1), among other systems. It should be appreciated that the functional schematic depicted in FIG. 2 is provided as an overview of functional capabilities for the DAT controller 228. In some embodiments, the vehicle 202 may include more or fewer modules and control systems.

The DAT controller 228 can obtain vehicle input information via the sensor system(s) 232. In particular, the DAT controller 228 may receive the sensor information associated with driver functions, and environmental inputs, and other information from the sensor system(s) 232.

The sensor system 232 may include an internal sensory system that may include any number of sensors configured in the vehicle interior (e.g., the vehicle cabin, which is not depicted in FIG. 2). Similarly, the sensor system 232 may include an external sensory system that may be configured in vehicle exterior. The external sensory system and internal sensory system can connect with and/or include one or more inertial measurement units (IMUs), camera sensor(s), fingerprint sensor(s), and/or other sensor(s). The DAT controller 228 may obtain, from the external and internal sensory systems, sensory data that can include external sensor response signal(s) and internal sensor response signal(s), via the sensor I/O module 238.

The camera sensor(s) may include thermal cameras, RGB (Red Green Blue) cameras, NIR (Near Infrared) cameras and/or a hybrid camera having thermal, RGB, NIR, or other sensing capabilities. Thermal cameras may provide thermal information of objects within a frame of view of the camera(s), including, for example, a heat map figure of a subject in the camera frame. A standard camera may provide color and/or black-and-white image data of the target(s) within the camera frame. The camera sensor(s) may further include static imaging, or provide a series of sampled data (e.g., a camera feed) to the biometric recognition module 242.

The IMU(s) may include a gyroscope, an accelerometer, a magnetometer, or other inertial measurement devices.

The sensor system 232 may further include any number of devices configured or programmed to generate signals that help navigate the vehicle 202 operating in an autonomous mode. The autonomous driving sensors may help the vehicle 202 “see” the roadway and the vehicle surroundings and/or negotiate various obstacles while the vehicle 202 is operating in the autonomous mode. In some aspects, the sensor system 232 may monitor vehicles travelling in a vehicle front side (such as a lead vehicle), vehicles travelling in a vehicle rear side (such as a trailing vehicle), and vehicles approaching or located in a vehicle blind spot area (both left and right blind spot area). The sensor system 232 may include, for example, one or more of proximity sensors, a Radio Detection and Ranging (RADAR or “radar”) sensor (configured for detection and localization of objects using radio waves), a Light Detecting and Ranging (LiDAR or “lidar”) sensor, a vision sensor system having trajectory, obstacle detection, object classification, augmented reality, and/or other capabilities, and/or the like. Further, the sensor system 232 may include vehicle speed sensors that may monitor vehicle 202 speed.

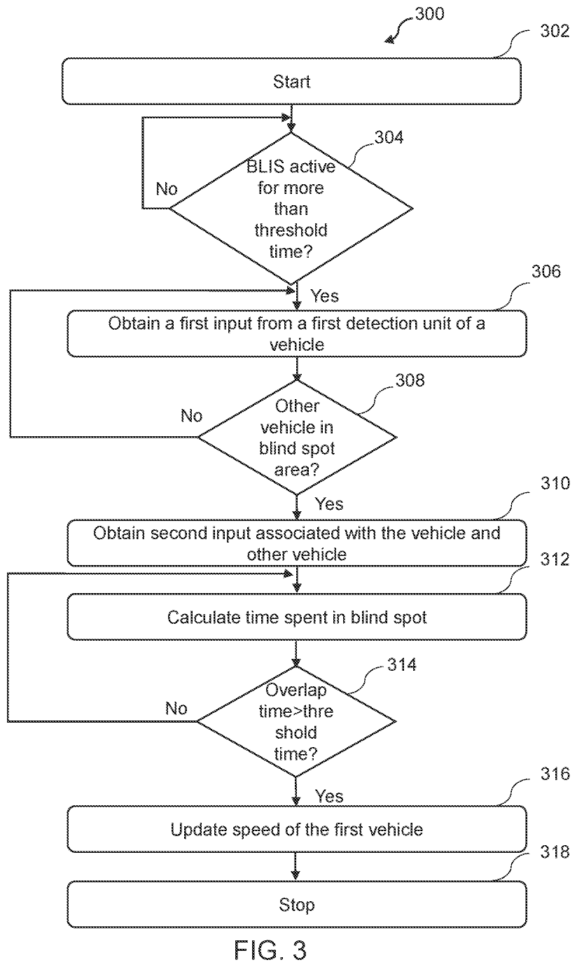

FIG. 3 depicts a first flow diagram of an example method 300 for automated control of vehicle longitudinal movement in accordance with the present disclosure. FIG. 3 may be described with continued reference to prior figures, including FIGS. 1-2. The following process is exemplary and not confined to the steps described hereafter. Moreover, alternative embodiments may include more or less steps that are shown or described herein and may include these steps in a different order than the order described in the following example embodiments.

In particular, the method 300 described below may start when the processor 214 activates the BLIS module 248. The processor 214 may activate the BLIS module 248 based on a vehicle user request, sent via the mobile device 210 or a vehicle infotainment system 258. In other aspects, the processor 214 may activate the BLIS module 248 automatically. For example, the processor 214 may activate the BLIS module 248 when the vehicle 202 reaches a speed greater than 30 mph.

The method 300 may commence at step 302. At step 304, the method 300 may include determining, by the adaptive cruise control (ACC) module 256, whether the BLIS module 248 is active for a time period that is greater than a threshold time period. Responsive to a determination that the time period is less than the threshold time period, the method 300 may wait until the BLIS module 248 is active for a time period that is greater than the threshold time period. The method 300 may move to step 306 when the ACC module 256 determines that the BLIS module 248 is active for the time period that is greater than the threshold time period.

At step 306, the method 300 may include obtaining, by the ACC module 256, a first input from a first detection unit of the vehicle detection units. Specifically, the ACC module 256 may obtain the first input from the first detection unit via the BLIS module 248. In some aspects, the first detection unit may be one of the sensors in the sensor system 232, and may include radar sensors that may be configured to monitor vehicles in the vehicle blind spot area 115 using radio waves. The first input may include an indication of surrounding vehicles and/or obstacles in proximity to the vehicle 202. In some aspects, the ACC module 256 may obtain the first input from the first detection unit/radar sensors at a preset frequency.

At step 308, the method 300 may include determining, by the ACC module 256, presence of the other vehicle 120 in the vehicle blind spot area 115 based on the first input. When the ACC module 256 determines the other vehicle 120 presence in the vehicle blind spot area 115, the method 300 moves to step 310. In alternative aspects, the BLIS module 248 may itself determine the other vehicle 120 presence based on the first input received from the first detection unit, and may send a confirmation signal to the ACC module 256 when the BUS module 248 detects the other vehicle 120 presence.

On the other hand, if the ACC module 256 (or the BUS module 248) does not detect the other vehicle 120 presence at the step 308, the ACC module 256 (or the BUS module 248) may continue to obtain the first input from the first detection unit and detect the other vehicle 120 presence, till the other vehicle 120 presence is detected.

At step 310, the method 300 may include obtaining, by the ACC module 256, a second input from a second detection unit and a third detection unit of the vehicle detection units/sensor system 232. The second input may be a vehicle 202 velocity and the other vehicle 120 velocity. The second detection unit may be configured to detect the vehicle 202 velocity and send it to the ACC module 256 (via the BUS module 248). In some aspects, the second detection unit may include speed sensor(s) or speed camera(s) that may be part of the sensor system 232. The third detection unit may be configured to detect the other vehicle 120 velocity. In some aspects, the third detection unit may include radar sensors, vehicle exterior cameras, ultrasonic sensor etc., which may be part of the sensor system 232.

A person ordinarily skilled in the art may appreciate that the vehicle 202 velocity and the other vehicle 120 velocity may include both speed and direction of respective vehicles. At step 310, the method 300 may further include calculating, by the ACC module 256, a relative velocity between the vehicle 202 and the vehicle 120 based on the second input (i.e., based on the obtained vehicle 202 velocity and the other vehicle 120 velocity).

At step 312, the method 300 may include calculating or estimating, by the ACC module 256, a time spent by the other vehicle 120 (or a time that the other vehicle 120 may spend) in the vehicle blind spot area 115. In some aspects, the ACC module 256 may calculate or estimate the time spent based on the calculated relative velocity between the vehicle 202 and the other vehicle 120. In other aspects, the ACC module 256 may determine/estimate the time spent based on the obtained first input. In further aspects, the ACC module 256 may determine/estimate the time spent based on relative distance between the vehicle 202 and the other vehicle 120, which may be calculated based on the obtained first input.

At step 314, the method 300 may include determining, by the ACC module 256, whether the calculated time spent is greater than a predetermined threshold. For instance, the predetermined threshold may be 5-7 seconds. In this scenario, the ACC module 256 may determine whether the other vehicle 120 is in the vehicle blind spot area 115 for more than 5-7 seconds. The method 300 may move to step 316 when the ACC module 256 determines that the time spent is greater than the predetermined threshold. Alternatively, the ACC module 256 may continue to obtain the second input, calculate the time spent, and determine whether the time period is greater than the predetermined threshold at the step 314.

At step 316, the method 300 may include updating, by the ACC module 256, the vehicle 202 speed so that the other vehicle 120 may move away from the vehicle blind spot area 115. The details of this step may be understood in conjunction with FIG. 4.

The method 300 may end at step 318.

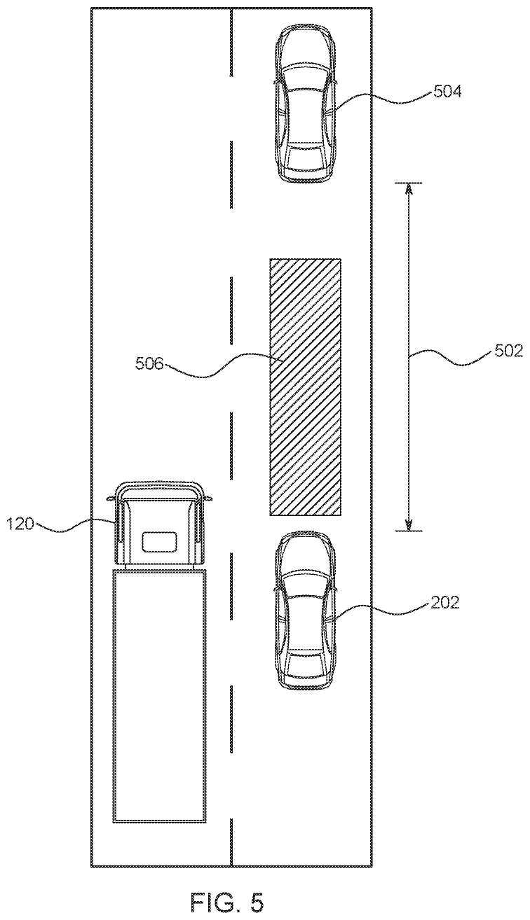

FIG. 4 depicts a second flow diagram of an example method 400 for updating vehicle 202 speed in accordance with the present disclosure. FIG. 4 may be described with continued reference to prior figures, including FIGS. 1-3. The following process is exemplary and not confined to the steps described hereafter. Moreover, alternative embodiments may include more or less steps that are shown or described herein and may include these steps in a different order than the order described in the following example embodiments. While explaining FIG. 4, reference may be made to FIG. 5. Specifically, FIG. 5 depicts an exemplary scenario for automated control of vehicle 202 longitudinal movement (i.e., the vehicle 202 speed), in accordance with the present disclosure.

The method 400 commence at step 402. In particular, the method 400 may start when the ACC module 256 determines that the time that the other vehicle 120 has spent in the vehicle blind spot area 115 is greater than the predetermined threshold (as described in FIG. 3). At step 404, the method 400 may include obtaining, by the ACC module 256, a first vehicle range 502 (shown in FIG. 5) for the vehicle 202. In particular, the ACC module 256 may obtain the first vehicle range 502 from a fourth detection unit of the one or more detection units/sensor system 232. The fourth detection unit may be radar sensors, vehicle cameras, etc., which may be installed in the vehicle 202. The first vehicle range 502 may be a current distance/range between the vehicle 202 and a lead vehicle 504.

At step 406, the method 400 may include determining, by the ACC module 256, whether the first vehicle range 502 is greater than a run-off area 506. In particular, the ACC module 256 may compare the first vehicle range 502 and the run-off area 506, and determine whether the first vehicle range 502 is greater than the run-off area 506. The run-off area 506 may be a minimum area or range that may be required to increase the vehicle 202 speed, while maintaining a predetermined distance from the lead vehicle 504. The run-off area 506 may be a function of the vehicle 202 speed, a time gap between the vehicle 202 and the lead vehicle 504, vehicle hysteresis and/or the like. In other words, the ACC module 256 may determine whether it is possible to increase the vehicle 202 speed without getting in contact with the lead vehicle 504.

Responsive to a determination that the first vehicle range 502 is greater than the run-off area 506, the method 400 moves to step 408. At step 408, the method 400 may include increasing, by the ACC module 256, the vehicle 202 speed such that the vehicle 202 may move ahead of the other vehicle 120. In other words, the ACC module 256 may control the vehicle 202 longitudinal movement so that the other vehicle 120 may not be in the vehicle blind spot area 115. In some aspects, the increased vehicle speed may be within the desired speed set by the vehicle operator (as described in conjunction with FIG. 1). In further aspects, the ACC module 256 may increase the vehicle 202 speed by transmitting instructions to the ECUs 208 (mainly the TCM 224) to increase the vehicle 202 speed to an updated vehicle speed. In this case, the ECUs 208 may update the vehicle 202 speed in response to receiving instructions from the ACC module 256.

At step 410, the method 400 may include determining, by the ACC module 256, whether the vehicle 202 has moved ahead of the other vehicle 120. In particular, the ACC module 256 may obtain inputs from the one or more detection units/sensor system 232 to determine a vehicle 202 location with respect to other vehicle 120 location. For example, the ACC module 256 may use vehicle cameras to determine whether the vehicle 202 has moved ahead of the other vehicle 120. Responsive to a determination that the vehicle 202 has moved ahead of the other vehicle 120, the method 400 may stop at 412. Alternatively, the method 400 may move back to the step 408 and continue to increase the vehicle 202 speed or maintain increased speed until the vehicle 202 overtakes the other vehicle 120.

On the other hand, if at the step 406, the ACC module 256 determines that the first vehicle range 502 is less than the run-off area 506, the method 400 may move to step 414. At step 414, the method 400 may include determining, by the ACC module 256, whether there is a trailing vehicle (not shown in FIG. 5) at a vehicle 202 rear side (e.g., within a predefined vehicle 202 rear range). In particular, the ACC module 256 may obtain inputs from a fifth detection unit of the one or more detection units/sensor system 232, which may be configured to monitor vehicles in the vehicle 202 rear side. The fifth detection unit may include vehicle camera, radar sensor, ultrasonic sensors, and/or the like. When the ACC module 256 detects the trailing vehicle at the step 414, the method 400 may stop at step 412. In this case, the ACC module 256 may not update the vehicle 202 speed.

On the other hand, responsive to a determination that there is no trailing vehicle within the predefined vehicle 202 rear range at the step 414, the method 400 may move to step 416. At step 416, the method 400 may include decreasing, by the ACC module 256, the vehicle 202 speed such that the vehicle 202 moves behind the other vehicle 120. Stated another way, the ACC module 256 may decrease the vehicle 202 speed such that the other vehicle 120 may move ahead of the vehicle 202 (and the respective driving lanes may remain unchanged). In this case, the ACC module 256 may control the vehicle 202 longitudinal movement (by decreasing the vehicle 202 speed) so that the other vehicle 120 may not be in the vehicle blind spot area 115. The decreased vehicle speed may be within the desired speed set by the vehicle operator (described in conjunction with FIG. 1). In some aspects, the ACC module 256 may decrease the vehicle 202 speed by transmitting instructions to the ECUs 208 (mainly the TCM 224) to decrease the vehicle 202 speed to an updated vehicle speed. The ECUs 208 may update the vehicle 202 speed in response to receiving the instructions from the ACC module 256.

At step 418, the method 400 may include determining, by the ACC module 256, whether the vehicle 202 is clear of the other vehicle 120. In particular, the ACC module 256 may obtain inputs from the one or more detection units/sensor system 232 to determine the vehicle 202 location with respect to the other vehicle 120 location. For example, the ACC module 256 may use vehicle cameras to determine whether the other vehicle 120 is ahead of the vehicle 202. Responsive to a determination that the other vehicle 120 is ahead, the method 400 may stop at 412. On the other hand, if the ACC module 256 determines that the other vehicle 120 is not ahead, the ACC module 256 may continue to decrease the vehicle 202 speed or maintain the decreased speed till the other vehicle 120 moves ahead.

In some aspects, the ACC module 256 may display the increased or decreased vehicle 202 speed on the infotainment system 258, installed in the vehicle 202.

The method 400 may include additional steps (that are not shown in FIG. 4) to update the vehicle 202 speed based on whether more than one “other” vehicles are present in the vehicle blind spot areas 115 (e.g., left blind spot area and right blind spot area). In particular, in response to a determination that that the time that the other vehicles 120 (i.e., more than one other vehicle) have spent in the vehicle blind spot areas 115 is greater than the predetermined threshold (described in FIG. 3), the ACC module 256 may determine whether the other vehicles 120 are travelling in both the left and right blind spot areas. In particular, the ACC module 256 may determine whether the vehicle 202 is travelling in left most lane, right most lane, or any middle lane. Thereafter, the ACC module 256 may determine whether the other vehicles 120 are travelling in vehicle left blind spot area and/or vehicle right blind spot area. The ACC module 256 may perform the determination by using inputs from the first detection unit.

Responsive to a determination that the other vehicles 120 are travelling in either the vehicle left blind spot area or the vehicle right blind spot area, the ACC module 256 may control the vehicle 202 speed, as discussed above. In other aspects, when the ACC module 256 determines that the other vehicles 120 are travelling in both the vehicle left blind spot area and the vehicle right blind spot area, the ACC module 256 may perform arbitration between the left and right side other vehicles 120 and update the vehicle 202 speed. In other words, the ACC module 256 may perform the steps mentioned above for both the left side other vehicle and the right side other vehicle, and correlate the updated speeds with respect to both the left and right side other vehicles to obtain a final updated vehicle 202 speed. The ACC module 256 may transmit the final updated vehicle 202 speed to the ECUs 208 (i.e., the TCM 224) for controlling the vehicle 202 speed (i.e., for increasing or decreasing the vehicle 202 speed).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a first detection unit configured to monitor vehicles in a first vehicle blind-spot area;
a control unit communicatively coupled to the first detection unit, wherein the control unit is configured to:
obtain a first input from the first detection unit;
determine presence of a second vehicle in the first vehicle blind-spot area based on the first input;
calculate a time spent by the second vehicle in the first vehicle blind-spot area;
determine whether the time spent is greater than a predetermined threshold;
compare a first vehicle range and a run-off area in response to the time spent being greater than the predetermined threshold; and
update a first vehicle speed based on the comparison.

2. The first vehicle of claim 1, wherein the control unit is further configured to:
determine whether the first vehicle range is greater than the run-off area; and
update the first vehicle speed based on the first vehicle range being greater or less than the run-off area.

3. The first vehicle of claim 2, wherein the update of the first vehicle speed comprises:
increase the first vehicle speed based on the first vehicle range being greater than the run-off area; or
decrease the first vehicle speed based on the first vehicle range being less than the run-off area.

4. The first vehicle of claim 1 further comprising:
a second detection unit configured to monitor vehicles in a first vehicle rear side,
wherein the control unit is configured to:
obtain a second input from the second detection unit; and
update the first vehicle speed based on the second input.

5. The first vehicle of claim 4, wherein the control unit is configured to decrease the first vehicle speed when there is no vehicle at the first vehicle rear side.

6. The first vehicle of claim 1, further comprising:
a third detection unit configured to detect a first vehicle velocity; and
a fourth detection unit configured to detect a second vehicle velocity.

7. The first vehicle of claim 6, wherein the control unit is further configured to:
obtain a third input from the third detection unit and the fourth detection unit;
calculate relative velocity between the first vehicle and the second vehicle based on the third input; and
determine the time spent based on the relative velocity.

8. The first vehicle of claim 1, wherein the first detection unit comprises radar sensors.

9. The first vehicle of claim 1, wherein the first detection unit is configured to monitor vehicles at a first vehicle left side blind-spot area and a first vehicle right side blind-spot area.

10. The first vehicle of claim 9, wherein the control unit is configured to adjust the first vehicle speed based on monitoring of vehicles at the first vehicle left side blind-spot area and the first vehicle right side blind-spot area.

11. The first vehicle of claim 1, wherein the first vehicle range is a distance between the first vehicle and a lead vehicle.

12. A method to control speed of a first vehicle, the method comprising:
obtaining, by a processor, a first input from a first detection unit, wherein the first detection unit is configured to monitor vehicles in a first vehicle blind-spot area;
determining, by the processor, presence of a second vehicle in the first vehicle blind-spot area based on the first input;
calculating, by the processor, a time spent by the second vehicle in the first vehicle blind-spot area;
determining, by the processor, whether the time spent is greater than a predetermined threshold;
comparing, by the processor, a first vehicle range and a run-off area in response to a determination that the time spent is greater than the predetermined threshold; and
updating, by the processor, a first vehicle speed based on the comparison.

13. The method of claim 12, further comprising:
determining whether the first vehicle range is greater than the run-off area; and
updating the first vehicle speed based on the first vehicle range being greater or less than the run-off area.

14. The method of claim 13, wherein updating the first vehicle speed comprises:
increasing the first vehicle speed based on the first vehicle range being greater than the run-off area; or
decreasing the first vehicle speed based on the first vehicle range being less than the run-off area.

15. The method of claim 12 further comprising:
obtaining a second input from a second detection unit, wherein the second detection unit is configured to monitor vehicles in a first vehicle rear side; and
update the first vehicle speed based on the second input.

16. The method of claim 15 further comprising decreasing the first vehicle speed when there is no vehicle at the first vehicle rear side.

17. The method of claim 12 further comprising:
obtaining a third input from a third detection unit and a fourth detection unit, wherein the third detection unit is configured to detect a first vehicle velocity and the fourth detection unit is configured to detect a second vehicle velocity;
calculating relative velocity between the first vehicle and the second vehicle based on the third input; and
determining the time spent based on the relative velocity.

18. A non-transitory computer-readable storage medium having instructions stored thereupon which, when executed by a processor, cause the processor to:
obtain a first input from a first detection unit of a first vehicle, wherein the first detection unit is configured to monitor vehicles in a first vehicle blind-spot area;
determine presence of a second vehicle in the first vehicle blind-spot area based on the first input;
calculate a time spent by the second vehicle in the first vehicle blind-spot area;
determine whether the time spent is greater than a predetermined threshold;
compare a first vehicle range and a run-off area in response to a determination that the time spent is greater than the predetermined threshold; and
update a first vehicle speed based on the comparison.

19. The non-transitory computer-readable storage medium of claim 18, having further instructions stored thereupon to:
determine whether the first vehicle range is greater than the run-off area; and
update the first vehicle speed based on the first vehicle range being greater or less than the run-off area.

20. The non-transitory computer-readable storage medium of claim 19, wherein the update of the first vehicle speed comprises:
increase the first vehicle speed based on the first vehicle range being greater than the run-off area; or
decrease the first vehicle speed based on the first vehicle range being less than the run-off area.
